(19) United States
(12) Patent Application Publication
(10) Pub. No.: US 2026/0244954 A1
(43) Pub. Date: Aug. 20, 2026

(54) Method and System for Processing Sparse Time Series Data

(71) Applicant: Tubr Ltd, London (GB)

(72) Inventors: Nikhil Kanta, London (GB); Evan-Alison Tabor, Sheffield (GB)

(73) Assignee: Tubr Ltd, London (GB)

(21) Appl. No.: 19/106,793

(22) PCT Filed: Feb. 28, 2023
(86) PCT No.: PCT/IB2023/584485

§ 371 Date: Feb. 26, 2025

(30) Foreign Application Priority Data
Aug. 29, 2022 (GB) 2212491.1

(51) Int. Cl. G06N 5/04

(52) U.S. Cl. CPC G06N 5/04

(57) ABSTRACT

Disclosed is a method for processing a sparse time series data. The method comprises receiving a dataset comprising the sparse time series data pertaining to real-world variables of a real-world system; transforming the sparse time series data to enable identifying data elements therein; processing the transformed time series data, for augmenting the transformed time series data and identifying the data elements and causal relationships between the data elements; reconstructing the transformed time series data into an operational model; and applying the operational model and the identified causal relationships to a machine learning algorithm to generate an output pertaining to the real-world variables of the real-world system.

### TECHNICAL FIELD

This invention relates to methods, systems, and computer program products for processing sparse time series data. In particular, though not exclusively, this invention relates to a method for processing sparse time series data, a system for processing sparse time series data, and a computer program product for processing sparse time series data.

### BACKGROUND

Conventionally, notable breakthroughs in artificial intelligence have relied on vast datasets, otherwise known as big data. Nowadays, artificial intelligence is popularly synonymous with big data. However, due to the uncertain nature of the world, data in big data is not available in a continuous manner. Hence, over the past decade, artificial intelligence has been implemented using small data, which is enough to comprehend dynamics in a given environment. Beneficially, the small data is in a volume and in a format that makes said data accessible, informative, and actionable. The small data can be used to find a causal relationship of an action and/or an event in a given system. Examples of the small data may include, but are not limited to, inventory data, sales data, biometric data, weather forecast data, usage alerts data, and the like. The small data is capable of impacting decisions, wherein the decisions may be personal decisions and/or business decisions at any given time.

Nowadays, a variety of datasets are applied to machine learning algorithms. Herein, the variety of datasets comprise data in various formats, wherein the various formats can be different in shape, size, comprehensiveness, and sparseness (i.e., sporadic). However, machine learning algorithms require the data to be in a structured format. Currently, machine learning algorithms are not workable with sparse or sporadic datasets. Notably, sparse or sporadic datasets make up around 90% of the collected time series data all over the world.

A conventional machine learning algorithm rarely understands dynamics between elements present in a given environment. The conventional machine learning algorithm, such as an open-source machine learning algorithm, is configured to use a general loss function to help understand the dynamics between the elements. Such a loss function is not able to capture dynamical elements of a system in its entirety and for the variety of datasets, thereby generating an inaccurate prediction. Long sequence time-series forecasting (LSTF) utilizes an efficient transformer-based model for time-series forecasting, such as forecasting of electricity consumption in a given area. However, the LSTF is able to work efficiently only when data is captured in a continuous manner in definite time intervals, such as half hourly, hourly, daily, weekly, monthly, yearly. The LSTF is not able to show accurate results when the dataset is a sparse or a sporadic dataset. A singular value decomposition (SVD)-combined tensor decomposition can be used to discover temporal patterns using missing data. However, their focus lies on recovering the missing data, rather than using the missing data. Spatiotemporal forecasting utilizes a diffusion convolutional recurrent neural network (a deep learning framework) to capture dependency using bidirectional random walks, and temporal dependency using an encoder-decoder architecture. However, such deep learning framework is not able to predict/forecast an output when something in the environment changes.

Therefore, in light of aforementioned discussion, there exists a need to overcome the aforementioned drawbacks associated with the conventional methods and systems for processing the sparse or sporadic datasets.

### SUMMARY OF THE INVENTION

A first aspect of the invention provides a method for processing a sparse time series data, the method comprising:
receiving a dataset comprising the sparse time series data pertaining to real-world variables of a real-world system;
transforming the sparse time series data to enable identifying data elements therein;
processing the transformed time series data, for augmenting the transformed time series data and identifying the data elements and causal relationships between the data elements;
reconstructing the transformed time series data into an operational model; and
applying the operational model and the identified causal relationships to a machine learning algorithm to generate an output pertaining to the real-world variables of the real-world system.

A technical benefit of processing the sparse time series data using the method is that the sparse time series data is efficiently manipulated, in a computationally-efficient manner, so that it is effectively usable by the machine learning algorithm to generate accurate and useful outputs. In particular, by augmenting the transformed time series data which is sparse, said transformed time series data is expanded (i.e., increased in size) while maintaining its integrity. Such data augmentation makes the (sparse) transformed time series data information-rich. Next, this transformed time series data that is augmented, is beneficially used to identify the data elements therein and the causal relationships between the data elements, so that all important contextual elements in the transformed time series data, and the causal relationships therebetween, are accurately identified. Advantageously, the operational model is reconstructed using the transformed time series data, and the data elements and the causal relationships that were identified, so that the operational model is optimized (to include a high level of data detail and data interrelations) based on the real-world system. When this operational model and the identified causal relationships are applied to the machine learning algorithm, the machine learning algorithm receives information-rich input (despite the original dataset being sparse), and thus generates meaningful inferences and/or draws accurate implications for practical use cases pertaining to the real-world system. Examples of the practical use cases may be, monitoring a spatial occupancy of people and/or goods in the real-world system, monitoring a movement of people and/or goods in the real-world system, monitoring weather conditions of the real-world system, and similar.

Throughout the present disclosure, the term “real-world system” refers to a given area in a real-world environment that is characterised by at least one of: a network of relationships, interconnections, interactions, between at least one entity present in the given area, wherein the given area can be a particular geographical area and/or location. Herein, the at least one entity can be at least one of: a living entity, a non-living entity. The monitored area is dynamic in nature, and can be represented using at least one of: a linear equation, a non-linear equation, a matrix, an n-dimensional model, and the like. Typically, a given entity present in the real-world system is related to another given entity in an established pattern, which is conventional in nature. This established pattern helps in determining the output of the at least one entity, more specifically, the living entity in the real-world system.

Throughout the present disclosure, the term “time series data” refers to a sequence of data that is collected over a period of time. Herein, the period of time may be a minute, an hour, 2 hours, 4 hours, 12 hours, 24 hours (a day), a week, a month, a year, and similar. The time series data can be at least one of: numeric data, alphanumeric data, qualitative data, primary data, secondary data. Examples of the time series data in the dataset may include, but are not limited to, Global Positioning System (GPS) data, traffic data, weather forecast data, video analytics data, partner data. The dataset is an information-rich functional set of data for every real-world variable. The dataset comprises the sparse time series data. Herein, the sparse time series data comprises values wherein at least some of the time-series data is present in the dataset, for example half of the data or more than half of the dataset, is either zero or empty. Optionally, the dataset comprises a sporadic time series data. Herein, the dataset comprises values taken at irregular intervals of time. Optionally, the dataset comprising the sparse time series data helps to track changes of the real-world variables of the real-world system.

Optionally, the dataset may be received in at least one of: a tabular form, a graphical form, a textual form. The dataset can be retrieved from a source, wherein the source is at least one of: a text file, a spreadsheet file, a database, a data warehouse, a data lake, a data mart, a cloud storage. Examples of the source may include, but is not limited to, Amazon Web Services® (AWS), Amazon Simple Storage Service® (S3), comma-separated values (CSV) files. Subsequently, the dataset is stored in a storage, wherein the storage is similar to the source but are used explicitly for storing purposes. Examples of the storage are similar to the examples of the source, but are used explicitly for storing purposes.

Throughout the present disclosure, the term “real-world variables” refers to quantitative variables pertaining to the real-world system. Herein, the real-world variables can be at least one of: a characteristic, a number, a quantity, that can be measured or counted. Optionally, the sparse time series data in the dataset depends on factors pertaining to the real-world system. These factors act as the real-world variables. Examples of the real-world variables may include, but are not limited to, age of the living entity and/or the non-living entity, sex of the living entity, capital expenditure, profit, revenue generated, colour of an object, ambient temperature of the real-world system, and the like.

Optionally, the sparse time series data constitutes 15%-25% of a total amount of time series data pertaining to the real-world variables. As an example, the sparse time series data may lie in a range from 15%, 17%, 20%, or 24% up to 16%, 20%, 23%, or 25%. Herein, the subsequently 75%-85% of the total amount of time series data is either zero or empty. A technical benefit of using the sparse time series data is that said sparse time series data is inherently available due to real-time constraints or irregular occurrences of the real-world variables. Beneficially, the sparse time series data reflects actual conditions of the real-world system, which makes the sparse time series data relevant to the real-world system. For example, a given dataset comprises a sparse time series data received from a device that is communicably coupled to five sensors, wherein the five sensors measure values of exemplary real-world variables pertaining to a real-world system (for example, such as an automobile). Herein, the real-world variables may be: a temperature, a speed, a fuel level, a status of door, an obstacle detection. The sparse time series data may be received continuously for a week. However, as four sensors out of the five sensors are not used every day of the week, hence, the given dataset may comprise 20% of the total amount of time series data pertaining to the real-world variables.

The sparse time series data can be transformed and represented by a linear equation,

$${x}_{t + n} = A ( {x}_{t} ) + {η}_{t} , t = 0 , 1 , 2$$

wherein, the real-world variables are xₜ, xₜ₊ₙ, and ηₜ. Herein, xₜ denotes a state of the real-world system at a time t. Herein, the time t is a non-negative integer. The function A maps the state xₜ at the time t to a succeeding time t+1. The variable ηₜ represents perturbation of the real-world system. Herein, the variable ηₜ incorporates a modelling error due to the uncertain nature and over-simplification of the linear equation. The modelling error may comprise at least one of: an error arising due to a slow change in at least one operating condition pertaining to the real-world variables, a discretization error. The state of the real-world system changes as a function of time.

Alternatively, optionally, the time series data pertaining to the real-world system can be transformed and represented as a linear time-invariant approximation of a non-linear system given by,

$${x}_{t + 1} = {Ax}_{t} + {η}_{t} , t = 0 , 1 , 2 …$$

Herein, the real-world system is entirely driven by the sparse time-series data. Hence, the real-world system is represented using high-dimensional observations in a non-linear equation which is given by,

$${y}_{t =} G ( {x}_{t} ) + {ξ}_{t} , t = 0 , 1 , 2 , … , T$$

wherein, the function G maps the state xₜ to a subspace Y, and variable ξₜ represents at least one measurement error. In other words, the function G may represent the real-world system, wherein the measurements at time t are also obtained.

Subsequently, the sparse time series data after transformation enable identifying the data elements pertaining to the real-world system. The data elements are useful key elements in the sparse time series data and are to be optionally identified based on a purpose for which the transformed time series data will eventually be processed by the machine learning algorithm. The data elements are to be identified to extract at least one of: at least one relationship of a given entity with another given entity, at least one relationship of a given entity with the real-world system. The at least one relationship may be at least one of: a topological relationship, a metric relationship, and an ordinal relationship. Herein, the at least one relationship could be the causal relationship between the data elements therein. It will be appreciated that the topological relationship is a connection between at least two entities in the real-world system, the metric relationship is defined by relationship of the given entity with a metric space in the real-world system, and the ordinal relationship is represented by relative orders among a plurality of entities present in the real-world system. Examples of the data elements may be, but are not limited to, spatial elements, environmental elements, contextual elements, of the real-world system.

In an instance when the practical use case could be monitoring the spatial occupancy in the real-world system, the data elements are spatial elements. The spatial elements could relate to movement of the given entity, with respect to the real-world system. Herein, the spatial elements could depict the metric space and the movement of the given entity using geometric properties, wherein the geometric properties include a position and a morphology of said entity in the real-world system. Herein, the spatial element may optionally be represented geometrically by at least one of: a point, a line string, a polygon. A position of a given spatial element is indicated by a pair of coordinates within the real-world system, namely, an X-coordinate and a Y-coordinate. For example, there may be a star, a road, and a boundary of a park, in the real-world system. The spatial elements may model the star as the point, the road as the line string, and the boundary of the park in a city as the polygon. The point may consist as either the X-coordinate or the Y-coordinate. Additionally, the line may consist as both the X-coordinate and the Y-coordinate representing a linear segment of the spatial element. Furthermore, the polygon may consist of pairs of coordinates. Optionally, the spatial element indicates a direction of the movement. The direction may be at least one of: a vertical direction, a horizontal direction, a diagonal direction, a radial direction. The spatial elements that relate to movement can be depicted using three-dimensional movement through a linear perspective.

In another instance, when the practical use case may be monitoring weather conditions in the real-world environment, the data elements could be environmental elements. The environment elements could pertain to environment factors, for example, such as temperature, humidity, solar radiation, wind speed, wind direction, and similar. In yet another instance, when the practical use case may be monitoring the movement of the people and/or the goods in the real-world system, the data elements could be the spatial elements and the contextual elements. The contextual elements could pertain to factors affecting the movement of the people and/or the goods, for example, time of a day, a day of a week, festivals, obstacles encountered during said movement, and similar.

Throughout the present disclosure, the term “causal relationship” refers to a cause-and-effect relation existing between each of the data elements within the real-world system. The causal relationships can be of two types, a direct causal relationship or an indirect causal relationship. In the direct causal relationship, the data elements are directly related to each other. In the indirect causal relationship, a given data element has an effect on an intermediary factor that, in turn, impacts other data elements.

Optionally, when the sparse time series data is represented by the linear equation, and a value of the perturbation is small, then the state xₜ₊₁ depends on a value of a previous state xₜ. In other words, given the function A, the state xₜ provides all information needed for identifying the causal relationship at the state xₜ₊₁. Alternatively, optionally, the function G in the non-linear equation is mapped to a collection of a plurality of ordered lists of n real numbers (Rⁿ) to a sub space Y. Furthermore, the subspace Y is a subset of the plurality of ordered lists of m real numbers (R^{m}). The dynamics of the real-world system are low-dimensional, i.e., G(xₜ), t=1, 2, . . . that lies on an n-dimensional manifold embedded in R^{m}. Additionally, when it is determined that the function G has an inverse, it is implied that a single data-point yₜϵY is enough to uniquely determine the corresponding state xₜ, thus determining the causal relationship in the non-linear equation.

Optionally, the step of processing the transformed time series data, for augmenting the transformed time series data and identifying the data elements and the causal relationships comprises:
deconstructing the transformed time series data, for augmenting the transformed time series data and identifying dynamics between the data elements; and
recognising the causal relationships by interconnecting the identified dynamics.

Herein, the term “dynamics” refers to patterns of behaviour that occur between the data elements in ways that the data elements relate, interact, and communicate with each other. Advantageously, the dynamics help to analyse the transformed time series data that include the causal relationships, and their underlying mathematics and logic, time delays and feedback. A technical effect of identifying the causal relationships in such a manner is that it helps to determine how a change in the given data element impacts the other data elements.

Optionally, when the dynamics are observable, the inverse of the function G can be met by vertically stacking several snapshots of the real-world system. For example, considering the practical use case of London underground railway network, said London underground railway network is designed to handle millions of passengers in a day. There may be up to 1 million passengers occupying the London underground railway network at a given time. Herein, an exemplary state xₜ may represent the sparse time series data of at least one of: a count of the passengers, an overall traffic movement, a weather state. An exemplary output yₜ may represent the sparse time series data of the count of the passengers. An exemplary value of the perturbation ηₜ may capture at least one of: a delay, a change of boundary conditions of the real-world system, at least one error. An exemplary variable ξₜ may model discretization and quantization errors.

Optionally, the dynamics of different real-world systems are different. For example, there may be two areas, namely, an underground rail transit system and a retail shop. Herein, both areas deal with individuals. However, the dynamics identified for the two areas are different. Exemplary dynamics related to the underground rail transit system comprise patterns of behaviour of individuals based on at least of: a demand at a given station, a schedule of trains, a flow of passengers at a given time period, a waiting time, crowding, number of trains deployed, a frequency of the trains, a cost for travelling, variable nature of crowding, ticket price during peak hours, ticket price during non-peak hours. Another exemplary dynamics related to retail shops comprises patterns of behaviour of individuals based on at least one of: the time of the day, the day of the week, the festivals, crowding, occupancy, neighbourhood, demand factors, physical surroundings of the retail shop, design elements (functional and aesthetic elements), social elements, goods and services offered, behavioural attributes.

Optionally, the step of deconstructing the transformed time series data, for augmenting the transformed time series data and identifying the dynamics comprises:
embedding the transformed time series data into d dimensions with T time delay for generating first embedded data, wherein d is determined via recursive searching and is achieved when a number of false nearest neighbours is small;
encoding the first embedded data for obtaining a global dynamics precursor Ω1;
splitting the transformed time series data into sequences of length W for forming split time series data;
embedding the split time series data into d′ dimensions with T′ time delay for generating second embedded data; and
encoding the second embedded data along with the split time series data for obtaining a local dynamics precursor Ω2.

In this regard, embedding is done to capture semantics of the transformed time series data by placing semantically similar data close together, thereby generating the first embedded data. A technical benefit of embedding is that fewer data points (for example, such as the sparse time series data), are enough to build an operational model. The dimension is recursively searched for within the transformed time series data, using a recursive search algorithm. Examples of the recursive search algorithm may include, but is not limited to, a recursive linear search, a recursive binary search. The number of false nearest neighbours is calculated using a false nearest neighbour algorithm. The false nearest neighbour algorithm is used to estimate a minimum required dimension d of the first embedded data. In the false nearest neighbour algorithm, for each point Rᵢ in the sparse time series data, a nearest neighbour \vec{R}ⱼ is searched for in a space of d dimension. Subsequently, a distance between the point Rᵢ and the nearest neighbour \vec{R}ⱼ is calculated. Subsequently, the point Rᵢ and the nearest neighbour \vec{R}ⱼ are iterated to compute,

$${R}_{i} = \frac{\vert {R}_{i + 1} - {R}_{j + 1} \vert}{‖ {\vec{R}}_{i} - {\vec{R}}_{j} ‖}$$

wherein, when the point Rᵢ exceeds a predefined threshold, said point is marked as having a false nearest neighbour. When the number of false nearest neighbours is small, then the dimension d is high enough for the first embedded data. The first embedded data captures the embedded dynamics and behaviour of an attractor present in the monitored area. The time delay T is determined using Mutual Information Estimation technique, which can be used for different time delays.

Subsequently, the first embedded data is encoded using a standard encoder. The standard encoder can be any of: an incremental encoder, an absolute rotary encoder, a linear encoder. The standard encoder is used to convert the first embedded data into a numerical data. A technical benefit of encoding the first embedded data is that it at least helps in making comparisons and deriving relationships of a given data with another data present in the first embedding data. This is beneficial for making recommendations based on said data. The global dynamics precursor Ω1 refers to any numeric value in the first embedding data that shows sudden deviation at a given time, from the numeric values present at a time prior to the given time. Typically, the transformed time series data follows conventional operational dynamics in a phase space. The term “phase space” refers to a multidimensional space in which each axis corresponds to at least one coordinate required to specify the state of the real-world system.

Optionally, the transformed time series data is represented by a matrix Y of an order n×m, and the split time series data is represented by a matrix y, of an order \hat{n}×\hat{m}×w. The sequences of the length W capture local dynamics of the split time series data by employing a general time series algorithm, such as a Sequence-to-Sequence (seq2seq) algorithm. Herein, the Sequence-to-Sequence algorithm takes a sequence of observations in time series and generates an output of another sequence of observations in time series.

Subsequently, the second embedded data is encoded using a similar standard encoder as used to encode the first embedded data. The standard encoder is used to convert the second embedded data into numerical data. The second embedded data is generated to capture the local dynamics along with a behaviour of local attractors. The local attractor represents a set of states towards which the real-world variables tend to evolve, for a variety of starting conditions of the system. The local attractor can be represented geometrically in two-dimensions or three-dimensions. The local attractor can be any of: a point, a finite set of points, a curve, a manifold, or a strange attractor. The local dynamics precursor Ω2 refers to any numeric value that shows a sudden deviation at a given time from the numeric values present at a time prior to the given time, in the second embedding data.

Optionally, the embedding of the transformed time series data and that of the split time series data are performed by implementing an attractor reconstruction using Takens' embedding function. The attractor reconstruction utilizes a dynamical attractor to infer at least one of: a geometrical information, a topological information from the transformed time series data. The Takens' embedding function utilises a compact manifold M of dimension m. For a pair of variables (φ, y), the variable φ is a smooth mapping of the compact manifold to itself, i.e., φ:M→M. The mapping is a smooth diffeomorphism. Herein, the smooth diffeomorphism is an invertible function that maps one differentiable manifold to another such that both the function and its inverse are smooth. The variable y is a smooth function that maps the compact manifold to a real function, i.e., y:M→R. Herein, a generic property is used. The generic property is that a (2m+1) delay observation map Φ_{(φ,y)}:M→R^{2m+1} is given by

$${Φ}_{( ϕ , y )} ( x ) = ( y ( x ) , y \cdot ϕ ( x ) , … , y \cdot {ϕ}^{2 m} ( x ) )$$

wherein, Φ_{(φ,y)}(x) is the embedding. Herein, the term “smooth” indicates that the function belongs to a differentiability class of C². In an instance, a measured time series y(1), y(2), . . . , y(N) lies on a D-dimensional attractor of an n^{th} order deterministic dynamical system. Herein, a starting point is chosen which is obtains an embedding from the transformed time series data. A convenient representation is achieved by using delay coordinates, for which a delay vector has a following form:

$$y ( k ) = {[ y ( k ) , y ( k - τ ) , … , y ( k - ( d - 1 ) τ ) ]}^{T}$$

wherein, d is the embedding dimension and T is the delay time. The Takens' embedding function utilises embeddings with d>2n, are faithfully generic so that there is a smooth map f: R^{d}→R such that

$$y ( k + 1 ) = f ( y ( k ) )$$

for all integers k, and where forecasting time T and T are also assumed to be integers.

Optionally, a time series observational data corresponding to the real-world system is obtained, wherein the time series observational data comprises observed values of at least one parameter that influences the real-world variables. In this regard, the time series observational data helps to understand the real-world system. The at least one parameter is different for different real-world systems. The at least one parameter may include: a parameter related to weather conditions of the given area, a parameter related to a given time, an economic parameter. Herein, the observed values of the at least one parameter depend on a given situation in the real-world system. Subsequently, the time series observational data is split into sequences of length W for forming split time series observational data, wherein obtaining the local operational precursor Ω2, the split time series observational data is encoded along with the second embedded data and the split time series data.

Optionally, the time series observational data is represented as a matrix X of order \hat{n}×\hat{l}×w. The split time series observational data may be encoded using the standard encoder. The split time series observational data can be directly decoded by utilising at least one skip connection. The operational model pertaining to the real-world system is a model that simulates at least one of: the data elements, the causal relationships between the data elements. The transformed time series data is used to reconstruct the operational model in a form of at least one of: another linear equation, another non-linear equation, a three-dimensional (3D) model, a visualisation, a model generated using machine learning techniques, and similar. The operational model is used to implement/support at least one of: an analysis, a design, a verification, a validation of the real-world system. The operational model is a representation of the real-world system, with the dynamics acting as constraints of said model. The operational model is trained based on the split time series data, the global dynamics precursor Ω1, the local dynamics precursor Ω2. The operational model is used to generate output pertaining to the real-world variables.

Optionally, the step of reconstructing the transformed time series data into the operational model comprises:
generating a customised loss function for the transformed time series data based on the identified dynamics, wherein the customised loss function indicates the dynamics of the real-world variables that are transferred to a general loss function; and
generating constraints for the customised loss function by using delay embedding on the transformed time series data, for augmenting the transformed time series data.

In this regard, the customised loss function is generated by obtaining a general loss function and a mean squared error of a previously-obtained dataset and a previously predicted dataset. A technical effect of generating the customised loss function is that said customised loss function is generated and implemented based on a particular requirement or a particular characteristic of the identified dynamics, based on the real-world system. Examples of the general loss function may include, but are not limited to, a regression, a loss function, a mean squared error loss function, a mean squared logarithmic error loss function, a mean absolute error loss function, and the like. The customed loss function may be maximised or minimised based on the nature of the prediction.

Subsequently, a constraint function is based on the global dynamics precursor Ω1 and the local dynamics precursor Ω2, wherein the constraint function varies according to at least one condition. These constraints can be generated on the transformed time series data using delay embedding, specifically, the Takens' embedding function. In this regard, the global dynamics precursor Ω1 and the local dynamics precursor Ω2 are extracted to derive the customised loss function for every previously-obtained actual dataset. The general loss function computes a distance between a current output and an expected output. Thereafter, the customised loss function is derived using the general loss function, the mean squared error, a summation of the constraint function, and an embedding function, which is given by,

$$ℒ = min \frac{1}{T - 1} {\sum }_{t = 0}^{T - 1} {‖ {y}_{a} - yp ‖}^{2} + λ {‖ \hat{Γ} ( {y}_{a} ) - \hat{Γ} ( {y}_{p} ‖}^{2} ) + κ {\sum }_{i} ρ ( {p}_{i} )$$

wherein, yₐ represents the previously-obtained actual dataset and yₚ represents the previously predicted dataset. λ and κ are tuning parameters that balances objectives of the. \hat{Γ} represents the Takens' embedding function. The constraint function varies according to at least one condition, wherein the at least one condition is given by,

$$ρ ( p ) := \{ \begin{matrix}{e}^{\frac{- \vert p - 1 \vert}{γ}} & if p < 0 \\ 0 & otherwise\end{matrix}$$

wherein, γ is a tuning parameter and p is at least one eigenvalue of a dynamical prior P, given the dynamical prior Ω=Ω₁Ω₂·_{P}. The dynamical prior P can be computed as

$$vec ( P ) = {( {Ω}^{T} ⊗ {Ω}^{T} - I )}^{+} vec ( - I )$$

wherein, I is an identity matrix. Derivatives of the at least one eigenvalue pᵢ and at least one eigenvector vᵢ of P are computed given by,

$$\partial {p}_{i} = {v}_{i}^{T} \partial ( P ) {v}_{i}$$

and,

$$\partial {v}_{i} = {( {p}_{i} \tilde{I} - P )}^{+} \partial ( P ) {v}_{i} .$$

The machine learning algorithm is used to generate the output, wherein the output is determined based on historical data (for example, such as reference data) which is used for training the machine learning algorithm. Herein, the historical data is generated by collecting time series data from the source (as mentioned earlier), and then processing the transformed time series data to identify therein reference causal relationships between reference data elements, and its corresponding reference output.

Optionally, the output comprises at least one of: an inference, a prediction, a decision, a rule, a function, pertaining to the real-world variables. In this regard, the machine learning algorithm is used to learn underlying patterns between the reference causal relationships and the reference output. Subsequently, a training function is inferred, based on the underlying patterns between the reference causal relationships and the output, wherein said training function can optionally be applied to existing causal relationships and existing output. Such training functions may be mathematical functions, a fuzzy relationship, a formula, and similar. Examples of the machine learning algorithms may include, but are not limited to Support Vector Machines algorithm, deep neural network algorithm, a Naïve Bayes algorithm. Such machine learning algorithms are well-known in the art. Through the training process, the machine learning algorithm undergoes supervised learning. Hence, the reference output is pre-processed in a form suitable for the machine learning algorithm chosen in order to generate the output.

When the output comprises the inference, the machine learning algorithm is used to draw conclusions about the dataset based on the underlying patterns identified between the reference causal relationships and the output. When the output comprises the prediction, the machine learning algorithm is used to generate a forecast or an estimation, pertaining to the real-world variables, based on underlying patterns identified during training. Optionally, the underlying patterns are identified via use of Hidden Markov Models. When the output comprises the decision, the machine learning algorithm is used to generate an action that is made with respect to underlying patterns identified during the training, and the real-world variables. When the output comprises the rule, the machine learning algorithm is used to generate any of: a set of logical statements, a set of logical conditions, that describes the patterns between the causal relationships and the output. When the output comprises the function, the machine learning algorithm is used to generate any of: a mathematical function, a computational function, based on the underlying patterns identified during the training. A technical effect of applying the operational model is to help the machine learning algorithm train on a dataset comprising the sparse time series data and infer meaningful insights from said sparse time series data.

For example, an exemplary real-world system may be an underground rail transit system. The output may comprise a prediction of the movement of people in the underground rail transit system. The predictions may be generated in 1-minute increments across all stations of the underground rail transit system. The predictions may be made every hour and may be extended up to 7 days in advance. Subsequently, the output may comprise another prediction of spatial occupancy in the underground rail transit. Herein, the another prediction may be made every hour at a following frequency: predictions in 1-minute increments may be extended up to 7 days in advance, predictions in 15-minute increments may be extended up to 14 days in advance, predictions in 1-hour increments may be extended up to 21 days in advance.

Optionally, the method further comprises:
obtaining an actual dataset corresponding to the output, wherein the actual dataset comprises actual data pertaining to the real-world variables;
determining an accuracy of the output, by comparing the actual data with the output; and
generating a visualisation for representing the accuracy of the output.

In this regard, the actual dataset may be obtained from data resources, pertaining to the real-world system. The actual data is compared with the output to evaluate the performance of the operational model. The output acts as ground truth for the actual data, and helps in determining an efficacy of the operational model. The visualisation is generated to provide a reason and a logic behind the accuracy of predicting, to enable an accountability and transparency of the operational model. A technical benefit of generating the visualization is to analyse the accuracy of output generated by the machine learning algorithm, thereby enabling an identification of inaccuracies of the output very convenient.

Optionally, the output comprises the prediction that is usable for decision-making with respect to the real-world variables. A technical effect of using the output for the decision-making is that it enables to make informed decisions related to the real-world system, which has a tangible effect in the real-world system. In this regard, at least one objective is obtained that is required to be fulfilled by the real-world variables. The at least one objective is obtained to use the operational model usable for decision-making to benefit shareholders of the real-world system. Optionally, the at least one objective is at least one of: a maximization of profits, maintenance of rules and regulations, adherence to safety and/or medical norms, optimal utilization of space and time, and similar. The output can be employed to derive the at least one objective. Hence, the prediction is used for choosing an accurate decision with respect to the real-world variables. For example, a prediction may be generated based on the movement of people and/or goods, and the spatial occupancy of the monitored area. This prediction may be used to derive characteristics comprising at least one of: demographic characteristics, lifestyle characteristics, related to the real-world system and associating these with the real-world system. The prediction based on the spatial occupancy of the monitored area may be used to discover patterns of behaviour of mobility, visits to a particular area, traffic route, and the like.

As an example, it may be predicted that traffic on a certain line of a railway network is high between 5 p.m. to 8 p.m., a decision with respect to increasing monetization may be taken based on such a prediction. The decision may be to raise ticket prices by 10% during said time-period, to charge 10% more than usual for advertising during said time period, or similar.

As another example, a spatial occupancy of the given area may be predicted to generate a forecast pertaining to the real-world variables of the given area. The prediction may be used to determine how to utilize the spatial occupancy in an optimized manner, the spatial occupancy being at least one of: a space occupied by the at least one entity, an interconnection of entities within a space, a spatial dimension of the at least one given entity. Hence, the prediction may be at least one of: a movement of the at least one entity within the monitored area, an occupancy of the at least one entity in the monitored area, and the prediction may further be used to establish and identify at least one of: another network of relationships, another interconnection, and another interaction, between another given entity with the remaining entities.

Optionally, the method further comprises:
obtaining additional data that is correlated to the real-world variables from at least one of: a user device associated with a user, a data repository; and
updating the output based on the additional data.

In this regard, the additional data is data that may be available after the operational model is developed and deployed. A technical benefit of obtaining the additional data is that it enables identification of other data elements and further recognition of other causal relationships between the other data elements, pertaining to the real-world system. A technical benefit of updating the at least one action based on the additional data is that it facilitates generating the output based on latest information (i.e., the additional data). The additional data can improve performance of the operational model when applied to the machine learning algorithm. The additional data may be generated when the operational model is evaluated upon with a different output that is to be carried out using the real-world variables. Hence, the output is updated based on the additional data, and also a combination of the additional data and the actual data. For example, for an underground rail transit system, an exemplary additional dataset correlated to the real-world variables may be a weather dataset.

Optionally, the term “user device” refers to a communication device which is accessible by a user. Examples of the user device include, but are not limited to, a laptop, a computer, a tablet, a phablet, a pager, a smartphone, a smartwatch, a smart device. The term “data repository” refers to hardware, software, firmware, or a combination of these for storing a given information in an organized (namely, structured) manner, thereby, allowing for easy storage access (namely, retrieval), updating and analysis of the given information. The data repository may be implemented as a memory of a device (such as the imaging system, the display apparatus, or similar), a removable memory, a cloud-based database, or similar. The data repository can be implemented as one or more storage devices. The data repository can be used to store at least one database. Optionally, the technical effect of using the data repository is that is provides an ease of storage and access of processing inputs, as well as processing outputs.

Optionally, the output can be represented in at least one of: a tabular format, a raw data set, a heat map, a graphical format. Herein, the tabular format is a convenient way to organize the output, wherein the output is organised as a data with rows and columns. The raw data set is a dataset that has not been pre-processed before using it. The raw data set can be collected using at least one of: a survey, online tracking, online marketing analytics, social media monitoring, transactional data tracking, and similar. The graphical format is a file structure comprising pictorial representation of the output. The heat map is a two-dimensional representation of the output, in which values of the output is represented by colours. The heat map provides immediate visual information by colours. For example, when the output comprises a prediction, and the prediction is related toa movement of people skiing across a mountain slope, the movement of people may be represented as a heat map across the entire mountain.

Optionally, the method further comprises updating the output in real-time or in near real-time according to any changes in the real-world variables. The output is continually updated to quickly determine an alternate decision, if required, based on the update. A technical benefit of updating the prediction dataset is that it makes the system highly accurate with at least one: complete prediction dataset, incomplete prediction dataset.

A second aspect of the invention provides a system for processing a sparse time series data, the system comprising at least one processor configured to execute steps of a method of the first aspect.

Throughout the present disclosure, the term “processor” relates to a computation element that is operable to respond to and process instructions. The at least one processor, in operation, implements the method for processing the sparse time series data. Furthermore, the term “processor” may refer to one or more individual processors, processing devices, and various elements associated with the processing device that may be shared by other processing devices. Such processors, processing devices and elements may be arranged in various architecture for responding to and executing steps of the method. The at least one processor is communicably coupled to the user device associated with the user, and the data repository.

Optionally, when processing the transformed time series data, for augmenting the transformed time series data and identifying the data elements and the causal relationships, the at least one processor is configured to:
deconstruct the transformed time series data, to augment the transformed time series data and to identify dynamics between the data elements; and
recognise the causal relationships by interconnecting the identified dynamics.

Optionally, the system further comprises a data repository communicably coupled to the at least one processor, wherein the data repository is configured to store thereat at least one of: the dataset comprising the sparse time series data pertaining to the real-world variables, the causal relationships. Optionally, the data repository is further configured to store thereat at least one of: dynamics between the data elements, a customised loss function, a constraint for the customised loss function, additional data.

A third aspect of the invention is a computer program product for processing a sparse time series data, the computer program product comprising a non-transitory machine-readable data storage medium having stored thereon program instructions that, when accessed by a processing device, cause the processing device to execute steps of the aforementioned method. The term “computer program product” refers to a software product comprising program instructions that are recorded on the non-transitory machine-readable data storage medium, wherein the software product is executable upon a computing hardware for implementing the aforementioned steps of the method for processing the sparse time series data.

In an embodiment, the non-transitory machine-readable date storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is an illustration of a flowchart depicting steps of a method for processing a sparse time series data, in accordance with an embodiment of the present disclosure;

FIG. 2 is an illustration of a block diagram representing a system for processing a sparse time series data, in accordance with an embodiment of the present disclosure; and

FIG. 3 is an illustration of a graphical representation of an output, when the output comprises a prediction that is usable for decision-making with respect to real-world variables, in accordance with an embodiment of the present disclosure.

### DETAILED DESCRIPTION

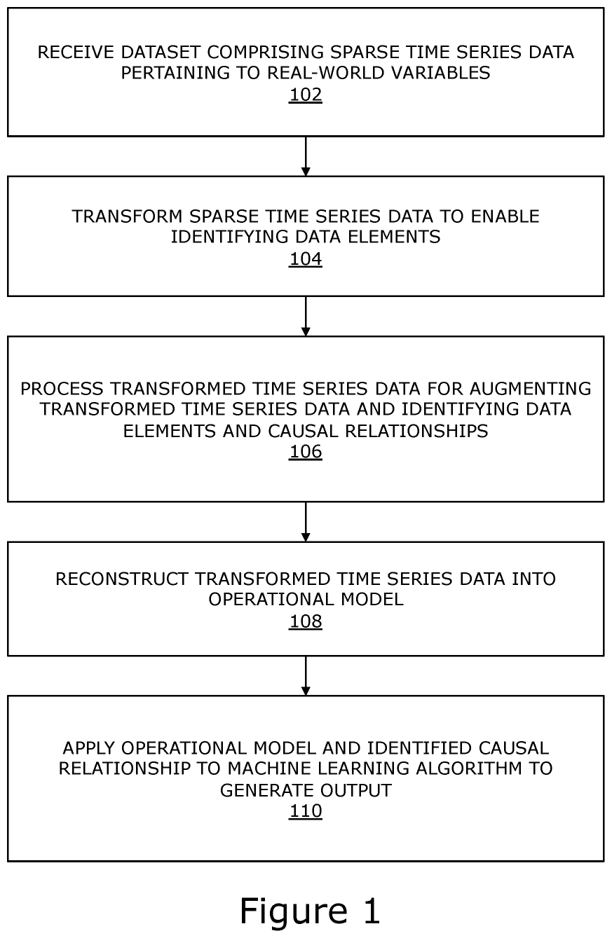

Referring to FIG. 1, illustrated is a flowchart depicting steps of a method for processing a sparse time series data, according to an embodiment of the present disclosure. At a step 102, a dataset is received, wherein the dataset comprises the sparse time series data pertaining to real-world variables of a real-world system. At a step 104, the sparse time series data is transformed to enable identifying data elements therein. At a step 106, the transformed time series data is processed, for augmenting the transformed time series data and identifying the data elements and causal relationships between the data elements. At a step 108, the transformed time series data is reconstructed into an operational model. At a step 110, the operational model and the identified causal relationships are applied to a machine learning algorithm to generate an output pertaining to the real-world variables of the real-world system.

The aforementioned steps are only illustrative and other alternatives can also be provided where one or more steps are added, one or more steps are removed, or one or more steps are provided in a different sequence without departing from the scope of the claims herein.

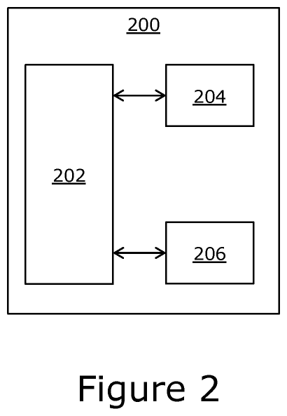

Referring to FIG. 2, illustrated is a block diagram of a system 200 for processing a sparse time series data, according to an embodiment of the present disclosure. The system 200 comprises at least one processor (depicted as at least one processor 202). The system 200 further comprises a data repository 204 and a user device 206 associated with a user, communicably coupled to the at least one processor 202.

### Example—Comparative Analysis

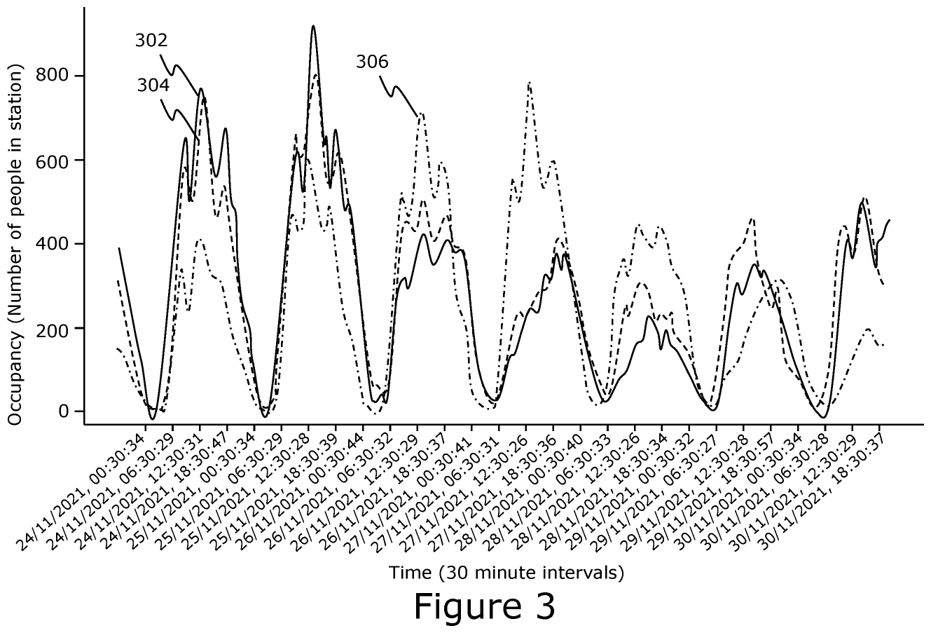

Referring to FIG. 3, illustrated is a graphical representation of an output, when the output comprises a prediction that is usable for decision-making with respect to real-world variables, according to an embodiment of the present disclosure. Herein, a spatial occupancy of a given area may be predicted to generate a forecast pertaining to the real-world variables of the given area. The prediction may be used to determine how to utilize the spatial occupancy in the given area in an optimized manner. The x-axis of the graphical representation represents the time in 30-minute intervals, and the y-axis represents the spatial occupancy of people in the monitored area. In the graphical representation, a bar 302 illustrates actual data related to spatial occupancy in the monitored area, a bar 304 illustrates a first prediction of spatial occupancy in the monitored area, wherein the first prediction is generated using the steps of the method as described in the present disclosure, and a bar 306 illustrates a second prediction of spatial occupancy, wherein the second prediction is generated using a conventional methodology. Herein, the first prediction and the second prediction are employed to determine which methodology gives least relative error with respect to the actual data related to the spatial occupancy of the monitored area, upon implementation. Notably, as illustrated by the bars 302, 304 and 306, it is observed that the bar 304 follows the bar 302 closely and has less relative error when compared to the bar 306. Hence, the first prediction is usable for decision-making with respect to real-world variables, as the first prediction is more accurate than the second prediction.

FIG. 3 is merely an example, which should not unduly limit the scope of the claims herein. A person skilled in the art will recognize many variations, alternatives, and modifications of embodiments of the present disclosure.

1. A method for processing a sparse time series data, the method comprising:
receiving a dataset comprising the sparse time series data pertaining to real-world variables of a real-world system;
transforming the sparse time series data to enable identifying data elements therein;
processing the transformed time series data, for augmenting the transformed time series data and identifying the data elements and causal relationships between the data elements;
reconstructing the transformed time series data into an operational model;
applying the operational model and the identified causal relationships to a machine learning algorithm to generate an output pertaining to the real-world variables of the real-world system, and
wherein processing the transformed time series data, for augmenting the transformed time series data and identifying the data elements and the causal relationships comprises:
deconstructing the transformed time series data, for augmenting the transformed time series data and identifying dynamics between the data elements;
recognising the causal relationships by interconnecting the identified dynamics; and
wherein the operational model is trained based on split time series data, a global dynamics precursor Ω1, and a local dynamics precursor Ω2.

2. (canceled)

3. A method according to claim 1, wherein the reconstructing the transformed time series data into the operational model comprises:
generating a customised loss function for the transformed time series data based on the identified dynamics, wherein the customised loss function indicates the dynamics of the real-world variables that are transferred to a general loss function; and
generating constraints for the customised loss function by using delay embedding on the transformed time series data, for augmenting the transformed time series data.

4. A method according to claim 1, wherein the output comprises a prediction that is usable for decision-making with respect to the real-world variables.

5. A method according to claim 1, further comprising:
obtaining additional data that is correlated to the real-world variables from at least one of: a user device associated with a user, a data repository; and
updating the output based on the additional data.

6. A method according to claim 1, wherein the sparse time series data constitutes in a range of 15% to 25% of a total amount of time series data pertaining to the real-world variables.

7. A method according to claim 1, wherein the output is represented in form of at least one of: a tabular format, a raw dataset, a heat map, a graphical format.

8. A method according to claim 1, further comprising updating the output in real-time or in near real-time according to any changes in the real-world variables.

9. A system for processing a sparse time series data, the system comprising at least one processor configured to execute a method of claim 1.

10. A system according to claim 9, wherein when processing the transformed time series data, for augmenting the transformed time series data and identifying the data elements and the causal relationships, the at least one processor is configured to:
deconstruct the transformed time series data, to augment the transformed time series data and to identify dynamics between the data elements; and
recognise the causal relationships by interconnecting the identified dynamics.

11. A system according to claim 9, further comprising a data repository communicably coupled to the at least one processor, wherein the data repository is configured to store thereat at least one of: the dataset comprising the sparse time series data pertaining to the real-world variables, the causal relationships.

12. A computer program product for processing a sparse time series data, the computer program product comprising a non-transitory machine-readable data storage medium having stored thereon program instructions that, when accessed by a processing device, cause the processing device to execute a method of claim 1.
